(19) United States
(12) Patent Application Publication
(10) Pub. No.: US 2022/0283826 A1
(43) Pub. Date: Sep. 8, 2022

(54) ARTIFICIAL INTELLIGENCE (AI) SYSTEM AND METHOD FOR AUTOMATICALLY GENERATING BROWSER ACTIONS USING GRAPH NEURAL NETWORKS

(71) Applicant: Lexie Systems, Inc., Dover, DE (US)

(72) Inventor: Maysam Lavasani, Los Altos, CA (US)

(21) Appl. No.: 17/689,633

(22) Filed: Mar. 8, 2022

Related U.S. Application Data
(60) Provisional application No. 63/157,974, filed on Mar. 8, 2021.

(51) Int. Cl. G06F 9/451; G06F 16/954; G06N 3/04; G06F 40/30

(52) U.S. Cl. CPC G06F 9/451; G06F 16/954; G06N 3/04; G06F 40/30

(57) ABSTRACT

For one embodiment of the present disclosure, an artificial intelligence (AI) system and method are disclosed herein for automatically generating browser actions using graph neural networks. A computer implemented method includes receiving, with an artificial intelligence (AI) agent, an input including a high-level natural language request or task or a text request or task, and in response to the input, automatically obtaining, with the AI agent, an html graph for a web application that is associated with the input. The method further includes automatically obtaining an appropriate domain specific semantic graph (DSG) in response to obtaining the html graph for the web application and based on a known set of DSGs and automatically generating, with a graph neural network (GNN), a labeled html graph in response to providing the html graph and the appropriate DSG to the GNN.

### RELATED APPLICATIONS

This application claims the benefit of U.S. Provisional Application No. 63/157,974, filed on Mar. 8, 2021, the entire contents of this U.S. Provisional application is hereby incorporated by reference.

### TECHNICAL FIELD

Embodiments described herein generally relate to the field of natural language processing, robotic process automation, and more particularly relates to automatically generating browser actions using graph neural networks.

### BACKGROUND

Conventionally, digitalization of manual processes over the last few decades had a large impact on the life of all human beings. Among other things, consumer can buy from the Internet, keep track of their financial info through the Internet, and communicate with each other through the Internet.

While these automations are making our life easier, many believe that we can do much better by using artificial intelligence (AI) technology.

Supporters of AI technology believe that AI is going to replace (and improve) software the way software replaced all of the manual issues.

### SUMMARY

For one embodiment of the present disclosure, an artificial intelligence (AI) system and method are disclosed herein for automatically generating browser actions using graph neural networks. A computer implemented method includes receiving, with an artificial intelligence (AI) agent, an input from a human, and in response to the input, automatically obtaining, with the AI agent, an html graph for a web application that is associated with the input including a high-level natural language request or task or a text request or task. The method further includes automatically obtaining an appropriate domain specific semantic graph (DSG) in response to obtaining the html graph for the web application and based on a known set of DSGs and automatically generating, with a graph neural network (GNN), a labeled html graph in response to providing the html graph and the appropriate DSG to the GNN.

### BRIEF DESCRIPTION OF THE DRAWINGS

FIG. 1 illustrates an example of a DSG for a pizza ordering task in accordance with one embodiment.

FIG. 2 is a flow diagram illustrating a method 200 for automatically generating browser actions using graph neural networks in response to an input utterance according to an embodiment of the disclosure.

FIG. 3 is a diagram of a computer system including a data processing system according to an embodiment of the invention.

### DETAILED DESCRIPTION OF EMBODIMENTS

The promise of AI technology is two fold. A software developer can build intelligent systems easier and faster by providing data and examples rather than going through time consuming process of software development. The systems that are using AI are going to be more and more intelligent since the cycle of innovation is faster (in some areas like vision for example the quality of AI based solutions are higher than software based non-AI solution and in some cases even better than the quality of human intelligence).

On the other hand, AI is suffering from a few problems. A lot of (labeled) data is a necessary criteria for high quality AI. Even if we can have enough data and build a high quality AI, it is hard to explain how it works and guarantee that it gives the right response in all different input scenarios. Basic common sense knowledge is not part of current AI systems and the AI systems have to learn everything from scratch (including the techniques for generalization/composition etc.).

Consumers typically use a large number of online merchants for ecommerce purchases. Each of these merchants typically requires onboarding of the consumer including personal information and password. The consumer is challenged to remember a large number of passwords and this can lead to user frustration when not able to quickly and easily make a purchase from a merchant application due to not being authenticated with the merchant application.

Methods and systems are described for an AI system having an AI agent to receive an html graph associated with a web application, to obtain an appropriate domain specific semantic graph (DSG) for the web application, and to automatically generate a labeled html graph based on the html graph and the DSG. The AI agent automatically learns a semantic for the web application without help from a software developer.

The AI agent can be a digital assistant to handle online ecommerce transactions for a consumer from a large number (e.g., hundreds) of merchant websites. The consumer provides an input (e.g., high-level natural language requests or tasks, text input for requests or tasks) to the digital assistant for various different merchant websites. The digital assistant will automatically handle the ecommerce transactions based on the conversational high-level natural language requests or tasks from the consumer. The digital assistant can learn user preferences, shopping history, habits, and recall past orders by name. The AI agent quickly onboards new merchants with zero merchant dependency for initial onboarding via a no-code tool. A merchant can also be integrated with a merchant's headless API.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

NLP: natural language processing

NLU: natural language understanding

NLG: natural language generation

In computer science, a graph is a data structure consisting of vertices and edges. A graph G is described a set vertices V and edges that G contains.

G=(V,E)

A graph neural network is a type of neural network that operates on the graph data structure. Graph neural networks (GNNs) are proven to be a powerful technology that enables learning important information about the graphs. GNNs can efficiently train a deep learning model for an important set of problems that can be represented by graphs. The training set consists of input graphs and the corresponding label information about graphs' nodes or even the label information associated with the part of the graphs or whole graphs. A GNN can perform node classification. Essentially, every node in a graph is associated with a label, and the GNN is used to predict a label of a node without ground truth.

The training and inference of GNNs is usually done by using message passing between the nodes to label the nodes with embedding values and then another neural network is used to aggregate the embedding values to generate the final prediction/classification result. The training happens on the GNN in an end-to-end fashion (both on the graph sections using message passing as well as the final section).

Browser actions are a set of activities that an end-user or a software program does with the browser to achieve a certain goal. For example, in order to search the latest information about the COVID virus, a user should open a browser, go to the google site, enter COVID news, and then click on the right link. Or, for placing a delivery order for a pizza a user should open the website for the pizza restaurant, go and find the pizza that she/he wants to buy, add it to the cart, enter delivery information, and checkout to complete the order.

A domain-specific semantic graph (DSG) is a graph that represents the relationship between the data and actions associated with a particular domain. For example, in a food ordering domain, we can have data like the list of food, list of specials and also we can have actions like “see menu”, “see menu for a given category of food”, “order a food”, “modify a food in an order”, “remove a food from order”, “favorite food list”, and “checkout”.

A DSG is generic for a line of business/industry and specifies the set of actions and the data in an abstract fashion. So the same DSG for food ordering can be used across all restaurants.

A DSG can be a specialized version of another DSG. For example, a DSG associated with ordering pizza is a special case of a food ordering DSG (the same way we have customization of software classes/objects in object oriented software design).

AI assistants that can automatically browse the web pages and perform actions on behalf of the users are becoming very popular. One of the applications of such AI assistants are when a user asks for an action in a natural language and the AI assistant goes to the corresponding web application, finds the series of pages that it needs to be visited in order to fulfill the user's request including entering the necessary information in the forms and then this way perform the requested task.

An important component of this AI assistant is the module that can understand the semantic of the web pages to perform the requested action.

For example, if the user wants the assistant to buy a certain food from the web page of a restaurant, the AI agent should understand the semantics behind the web pages and determine how should find the list of the foods, how should order that food, and how should enter information for delivering the food.

One solution to this problem is to have a human teach the AI agent these semantics per web application and then the AI agent can use what it learned for the same merchant. This solution requires time consuming and significant help/support from a human for training the agent per web application. Training the AI agent for numerous web applications can require years of time from a human.

Another solution is to have the AI agent learn the semantic by itself without any (major) help from the human. The human however can check the semantics that is automatically learned and extracted by the agent to make sure that the learning is indeed done correctly.

The present design provides a neural network that accepts (i) the html associated with a website and (ii) a DSG as the inputs and then labels the html with the DSG nodes.

In other words, the input to the GNN is two graphs (HTML graph of a web application) as well as DSG. The output of the GNN is the labeled HTML graph.

For example, the following is an abstract representation of an HTML application for a pizza restaurant:

```
topNode
  -store locations
  -order info
    --pickup
    --delivery
  -menu
    --pizza
      ---pepperoni (link to add to the cart)
      ---ham (link to add to the cart)
    --pasta
      ---chicken alfredo (link to add to the cart)
      ---Italian sausage (link to add to the cart)
    --drink
      ---lemonade (link to add to the cart)
      ---coke (link to add to the cart)
  -cart
    --add to the cart
    --remove from cart
    --checkout
```

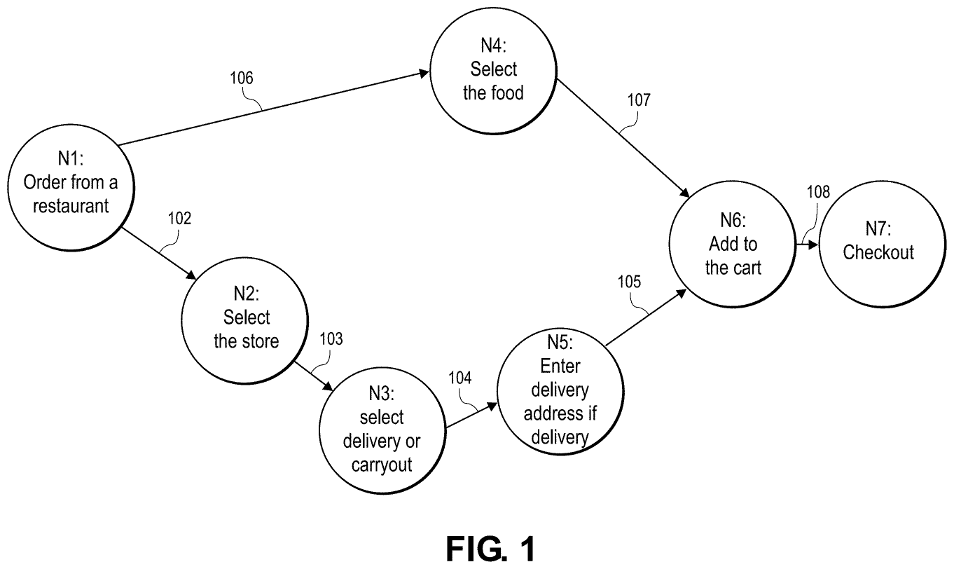

FIG. 1 illustrates an example of a DSG 100 for a pizza ordering task in accordance with one embodiment. The edges 102-108 between the DSG nodes N1 to N7 represent the logical dependencies between each of the actions for a node.

Our goal is to label the html using the DSG actions so if an AI agent wants to perform a certain task (e.g., ecommerce ordering, pizza ordering, financial trading, health care task, etc.), the AI agent can follow the actions based on a labeled html graph and finish or complete the task.

The following is an example of output of this training process of a graph neural network with the labeling being added in parentheses (e.g., labeled html for the same pizza restaurant):

```
topNode (N1)
  -store locations
    --list of locations that can be selected (N2)
  -Order info (N3)
    --delivery with input box to enter address (N5)
    --pickup
  -menu
    --pizza
      ---pepperoni (link to add to the cart) (N4)
      ---ham (link to add to the cart) (N4)
    --pasta
      ---chicken alfredo (link to add to the cart) (N4)
      ---Italian sausage (link to add to the cart) (N4)
    --drink
      ---lemonade (link to add to the cart) (N4)
      ---coke (link to add to the cart) (N4)
  -cart
    --add to the cart (N6)
    --remove from cart
    --checkout (N7)
```

Based on such html labeling, an automated agent can take the necessary browser actions to achieve a certain goal. For example, if a customer wants to order a pepperoni pizza the AI system can do this using the DSG across all the restaurants and since the website of all restaurants are labeled using DSG, we can order the food that we want for that specific restaurant.

The above example shows the case that we have a generic GNN that is built across all domains when we have a DSG for each domain and we feed the appropriately selected DSG to the GNN during the training.

Another alternative is to train a GNN per domain. Input samples (e.g., html graphs) for different web applications for a particular domain are provided to the GNN for the training. The AI agent crawls different web pages for the web applications (e.g., web 1.0, web 2.0, web 3.0 applications, etc.). Web 3.0 focuses on the interconnections between online assets to surface meaningful content and relevant resources intuitively (often powered by AI and ML). These are called semantic connections. Further, Web 3.0 could be a spatial internet where there are immersive worlds connected via the web to offer information and services in XR.

Numerous merchants for a particular domain (e.g., pizza restaurants, coffee shops, grocery, investment merchants, healthcare provider, apparel, clothing, etc.) can be quickly on boarded to the AI system with minimal human intervention based on the training of the GNN for the particular domain.

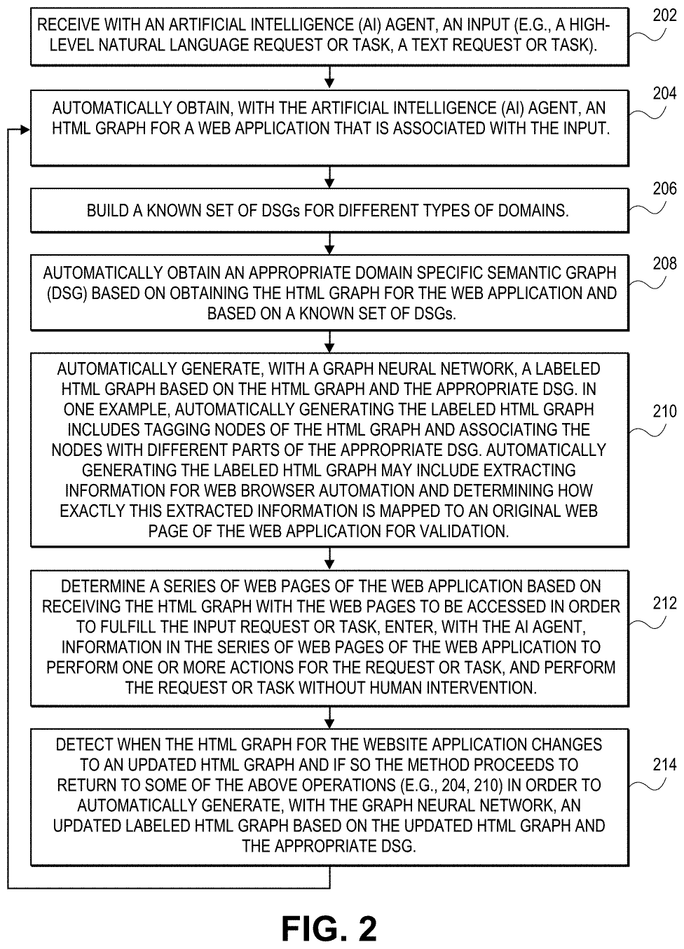

FIG. 2 is a flow diagram illustrating a method 200 for automatically generating browser actions using graph neural networks in response to an input (e.g., high-level natural language requests or tasks, text input for requests or tasks) according to an embodiment of the disclosure. Although the operations in the method 200 are shown in a particular order, the order of the actions can be modified. Thus, the illustrated embodiments can be performed in a different order, and some operations may be performed in parallel. Some of the operations listed in FIG. 2 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 200 may be executed by a computer system, a machine, a server, a web appliance, or any system, which includes processing logic to perform operations of an AI agent. The AI agent may include hardware (circuitry, dedicated logic, etc.), software (such as is run on a general purpose computer system or a dedicated machine or a device), or a combination of both. In one embodiment, processing logic performs the operations of method 200. The AI agent can be a software extension to a web browser for desktop and laptop browsing or the AI agent may be a companion app for a mobile device.

At operation 202, the computer implemented method includes receiving, with an artificial intelligence (AI) agent (or digital assistant), an input (e.g., high-level natural language requests or tasks, text input for requests or tasks, order a pizza or coffee, order a pizza from a specific pizza restaurant, order a coffee from a specific coffee merchant, etc.)) from a human.

At operation 204, the computer implemented method includes automatically obtaining, with the artificial intelligence (AI) agent, an html graph for a web application (e.g., specific pizza restaurant web application, specific coffee merchant web application, etc.) that is associated with the input (e.g., high-level natural language requests or tasks, text input for requests or tasks). At operation 206, the computer implemented method includes building a known set of DSGs for different types of domains. A human can supervise the building of the set of DSGs or write the DSBs.

At operation 208, the computer implemented method includes automatically obtaining an appropriate domain specific semantic graph (DSG) based on obtaining the html graph for the web application and based on a known set of DSGs. For example, if the AI agent receives an input for ordering a coffee from an online coffee merchant, then the AI agent will automatically select a DSG for online coffee merchants.

At operation 210, the computer implemented method includes automatically generating, with a graph neural network, a labeled html graph based on the html graph and the appropriate DSG. In one example, automatically generating the labeled html graph includes tagging nodes of the html graph and associating the nodes with different parts or components of the appropriate DSG. For example, the nodes can be tagged or labeled to create a product catalog with a hierarchy and product classification for an online merchant. If the human is ordered coffee from an online coffee merchant, then the product catalog includes a drink class for different types of drinks with properties (e.g., size) for a coffee drink, sub-properties (e.g., variations or options for the drink), price, coupons, and deals associated with the products, etc.

Automatically generating the labeled html graph may include extracting information for web browser automation and determining how exactly this extracted information is mapped to an original web page of the web application for validation.

Automatically generating the labeled html graph may include tagging nodes of the html graph to determine browsing actions to (i) log in, (ii) add the product to the cart, (iii) select the store location, (iv) enter payment info, (v) enter delivery info, and (vi) checkout.

At operation 212, the computer implemented method includes determining a series of web pages of the web application based on receiving the html graph with the web pages to be accessed in order to fulfill the input (e.g., high-level natural language requests or tasks, text input for requests or tasks), entering, with the AI agent, information in the series of web pages of the web application to perform one or more actions for the request or task, and performing the request or task without human intervention.

The computer implemented method uses the extracted information to translate the one or more inputs to one or more browsing actions that are completely automated by the AI agent. In one example, the human provides an input (e.g., high-level natural language requests or tasks, text input for requests or tasks, order a pizza) and the AI agent performs the operations of method 200. The AI agent may generate one or more voice outputs to ask the human to provide further information for the pizza order such as name of pizza merchant, location for the order, type of pizza, toppings on the pizza, drinks, etc. The human will respond with additional conversational style input utterances to respond to the voice output of the AI agent. The voice output of the AI agent can be synchronized with automated browsing actions (e.g., select a store location, select a type of pizza, select toppings for the pizza).

At operation 214, the computer implemented method can detect when the html graph for the website application changes to an updated html graph and if so the method proceeds to return to some of the above operations (e.g., operations 204, 210) in order to automatically generate, with the graph neural network, an updated labeled html graph based on the updated html graph and the appropriate DSG.

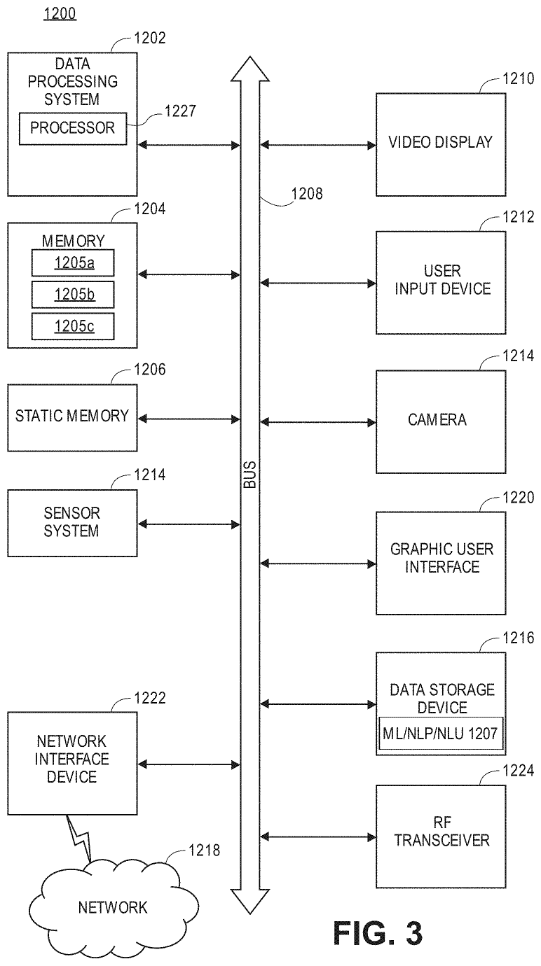

FIG. 3 is a diagram of a computer system (e.g., AI system) including a data processing system according to an embodiment of the invention. Within the computer system 1200 is a set of instructions for causing the machine to perform any one or more of the methodologies discussed herein including instructions for an AI agent. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227. The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The in-line accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 (or processing logic 1227) executes various software components stored in memory 1204 to perform various functions for system 1200. In one embodiment, the software components include operating system 1205a, compiler component 1205b to reuse existing software to augment the voice/nlu experiences without the need to reimplement a UI component, and communication module (or set of instructions) 1205c. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code).

A communication module 1205c provides communication with other devices utilizing the network interface device 1222 or RF transceiver 1224. The computer system 1200 may further include a network interface device 1222. In an alternative embodiment, the data processing system disclose is integrated into the network interface device 1222 as disclosed herein. The computer system 1200 also may optionally include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/di spreading, inverse fast Fourier transforming (IFFT)/fast Fourier transforming (FFT), cyclic prefix appending/removal, and other signal processing functions.

The Data Storage Device 1216 may include a machine-readable non-transitory storage medium (or more specifically a computer-readable non-transitory storage medium) on which is stored one or more sets of instructions embodying any one or more of the methodologies or functions described herein. In one example, machine learning models, NLP models, NLU models, webrobot training, AI agent, tabular training, or any other training 1207 to perform one or more of the methodologies or functions described herein are stored in the data storage device 1216. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

The computer-readable storage medium 1224 may also be used to one or more sets of instructions embodying any one or more of the methodologies or functions described herein. While the computer-readable storage medium 1224 is shown in an exemplary embodiment to be a single medium, the term “computer-readable storage medium” should be taken to include a single medium or multiple media (e.g., a centralized or distributed database, and/or associated caches and servers) that stores the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media. The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A computer implemented method comprising:
receiving, with an artificial intelligence (AI) agent, an input including a high-level natural language request or task or a text request or task;
in response to the input, automatically obtaining, with the AI agent, an html graph for a web application that is associated with the input;
automatically obtaining an appropriate domain specific semantic graph (DSG) in response to obtaining the html graph for the web application and based on a known set of DSGs; and
automatically generating, with a graph neural network (GNN), a labeled html graph in response to providing the html graph and the appropriate DSG to the GNN.

2. The computer implemented method of claim 1 wherein automatically generating the labeled html graph comprises tagging nodes of the html graph and associating the nodes with different parts of the appropriate DSG.

3. The computer implemented method of claim 1 wherein automatically generating the labeled html graph extracts information for web browser automation and explains how exactly this information is mapped to an original web page of the web application for validation.

4. The computer implemented method of claim 3 wherein automatically generating the labeled html graph comprises tagging nodes of the html graph to determine browsing actions to (i) log in, (ii) add the product to the cart, (iii) select the store location, (iv) enter payment info, (v) enter delivery info, and (vi) checkout.

5. The computer implemented method of claim 4, further comprising:
using the extracted information to translate the input to one or more browsing action completely automated by the AI agent.

6. The computer implemented method of claim 1, further comprising:
detecting when the html graph for the website application changes to an updated html graph;
automatically generating, with the GNN, an updated labeled html graph based on the updated html graph and the appropriate DSG.

7. The computer implemented method of claim 1 wherein nodes of the appropriate DSG nodes include product categories, products, product properties and variants, product prices, coupons, and deals associated with the products.

8. The computer implemented method of claim 1, further comprising:
determining a series of web pages of the web application based on receiving the html graph with the web pages to be accessed in order to fulfill the request or task.

9. The computer implemented method of claim 8, further comprising:
generating voice output and responding to the input with the voice output in order to obtain more information for fulfilling the request or task;
entering, with the AI agent, information in the series of web pages of the web application to perform one or more actions for the request or task; and
performing the request or task without human intervention.

10. The computer implemented method of claim 9, wherein a voice output of the AI agent and a corresponding automatically generated browsing action are synchronized.

11. A computer-readable non-transitory medium containing executable computer program instructions which when executed by a data processing system cause said system to perform a method, comprising:
receiving, with an artificial intelligence (AI) agent, an input including high-level natural language request or task;
in response to the input, automatically obtaining, with the AI agent, an html graph for a web application that is associated with the high-level natural language request or task;
automatically obtaining an appropriate domain specific semantic graph (DSG) in response to obtaining the html graph for the web application and based on a known set of DSGs; and
automatically generate, with a graph neural network (GNN), a labeled html graph in response to providing the html graph and the appropriate DSG to the GNN.

12. The computer-readable non-transitory medium of claim 11 wherein automatically generating the labeled html graph comprises tagging nodes of the html graph and associating the nodes with different components of the appropriate DSG.

13. The computer-readable non-transitory medium of claim 11 wherein automatically generating the labeled html graph extracts information for web browser automation and explains how exactly this information is mapped to an original web page of the web application for validation.

14. The computer-readable non-transitory medium of claim 13 wherein automatically generating the labeled html graph comprises tagging nodes of the html graph to determine browsing actions to (i) log in, (ii) add the product to the cart, (iii) select the store location, (iv) enter payment info, (v) enter delivery info, and (vi) checkout.

15. The computer-readable non-transitory medium of claim 14, the method further comprising:
using the extracted information to translate the high-level natural language request or task to one or more browsing action completely automated by the AI agent.

16. The computer-readable non-transitory medium of claim 11, the method further comprising:
detecting when the html graph for the website application changes to an updated html graph;
automatically generating, with the GNN, an updated labeled html graph based on the updated html graph and the appropriate DSG.

17. The computer-readable non-transitory medium of claim 1 wherein nodes of the appropriate DSG nodes include product categories, products, product properties and variants, product prices, coupons, and deals associated with the products.

18. The computer-readable non-transitory medium of claim 11, the method further comprising:
determining a series of web pages of the web application based on receiving the html graph with the web pages to be accessed in order to fulfill the high-level natural language request or task.

19. The computer-readable non-transitory medium of claim 18, the method further comprising:
generating voice output and responding to the input with the voice output in order to obtain more information for fulfilling the request or task;
entering, with the AI agent, information in the series of web pages of the web application to perform one or more actions for the request or task;
performing the request or task without human intervention.

20. The computer-readable non-transitory medium of claim 19, wherein a voice output of the AI agent and a corresponding automatically generated browsing action are synchronized.
